(19) United States
(12) Patent Application Publication
(10) Pub. No.: US 2005/0108501 A1
(43) Pub. Date: May 19, 2005

(54) Systems and methods for identifying unending transactions

(76) Inventors: Zachary Steven Smith, Ft. Collins, CO (US); John Warren Maly, Laporte, CO (US); Ryan Clarence Thompson, Loveland, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/700,288

(22) Filed: Nov. 3, 2003

(51) Int. Cl. G06F 15/00

(52) U.S. Cl. 712/1

(57) ABSTRACT

Disclosed are systems and methods for identifying unending transactions. In one embodiment, a system and a method pertain to monitoring an interface, determining whether a transaction has timed out, and flagging the transaction if it is determined that the transaction has timed out. In another method, a system and a method pertain to monitoring an interface, identifying a packet that arrives on the interface, determining whether the packet pertains to a transaction contained in a pending transaction list, and determining when the transaction should be completed if the transaction is not contained in the pending transaction list.

### BACKGROUND

Computer processor design is an extremely complex and lengthy process. The design process includes a range of tasks from high level tasks such as specifying the architecture down to low level tasks such as determining the physical placement of transistors on a silicon substrate. Each stage of the design process also involves extensive testing and verification of the design through that stage. One typical stage of processor design is to program the desired architecture for the processor using a register transfer language (RTL). The desired architecture is represented by an RTL specification that describes the behavior of the processor in terms of step-wise register contents. The RTL specification models what the processor does without describing the physical circuit details. Thus, the processor architecture can be verified at a high level with reference to the RTL specification, independent of implementation details such as circuit design and transistor layout. The RTL specification also facilitates later hardware design of the processor.

Manually verifying the RTL specification of the processor architecture is prohibitively complex during the design of a modern microprocessor. Therefore, multiple test cases are typically generated to test the design. Each test case contains input instructions and may also contain the desired results or outputs. Rather than running test cases through a simulation of the RTL specification and manually verifying the results, the test cases may be executed both on a simulation of the RTL specification (often compiled to increase speed) and on a “golden simulator” and the results compared. The golden simulator (GSIM) is a relatively-high level simulation of the processor architecture and therefore has a higher likelihood of accurately implementing the desired architecture than the RTL specification. The golden simulator may be implemented in any desired manner, such as a custom program written using a high-level programming language. Although the golden simulator is often a higher-level implementation of the processor architecture than the RTL specification, the golden simulator typically does go into enough detail to match the major structures in the RTL specification. For example, if the RTL specification describes a translation look aside buffer (TLB), the golden simulator may also implement a TLB to enable full testing and comparison of the RTL specification.

Test cases may thus be executed both on the RTL specification and the golden simulator, so that the results can be compared. Any difference in the results indicates an error in the RTL specification, the golden simulator, or both, although in theory the golden simulator is more likely to be error-free than the RTL specification.

There are several obstacles to effectively verifying the design of a processor using the above-described techniques. Once such obstacle is identifying transactions that are initiated but which do not complete. To cite an example, a given simulated processor may generate many transactions (e.g., read requests, write requests, etc.), each of which has certain defined finish criteria that indicate when the transaction is completed. If a given transaction does not end, there is a potential a flaw in the processor design. Unfortunately, the occurrence of such an unending transaction may not be identified during the verification testing. In such a case, the processor designer may be ignorant of a potential flaw in the processor design, and discovery of the flaw may be delayed until late in the design process, or even after processor fabrication has been completed.

### SUMMARY

Disclosed are systems and methods for identifying unending transactions. In one embodiment, a system and a method pertain to monitoring an interface, determining whether a transaction has timed out, and flagging the transaction if it is determined that the transaction has timed out.

In another method, a system and a method pertain to monitoring an interface, identifying a packet that arrives on the interface, determining whether the packet pertains to a transaction contained in a pending transaction list, and determining when the transaction should be completed if the transaction is not contained in the pending transaction list.

### BRIEF DESCRIPTION OF THE DRAWINGS

The disclosed systems and methods can be better understood with reference to the following drawings. The components in the drawings are not necessarily to scale.

FIG. 1 is a block diagram of an exemplary system for verifying a processor architecture.

FIG. 2 is a block diagram of an alternative exemplary system for verifying a processor architecture.

FIG. 3 is a block diagram of an exemplary system of computer components connected by a front side bus.

FIG. 4 is a block diagram of an exemplary system of computer components connected by a point-to-point link network.

FIG. 5 is a block diagram illustrating exemplary logical data flow in a point-to-point link network between a group of processor cores and a memory, illustrating a read operation coordinated by a simple memory agent.

FIG. 6 is a flow diagram of an exemplary operation for verifying a processor architecture.

FIGS. 7A and 7B provide an example of operation of a virtual bus interface in identifying unending transactions.

FIG. 8 is a flow diagram that summarizes a method for identifying an unending transaction.

FIG. 9 is a flow diagram that summarizes another method for identifying an unending transaction.

### DETAILED DESCRIPTION

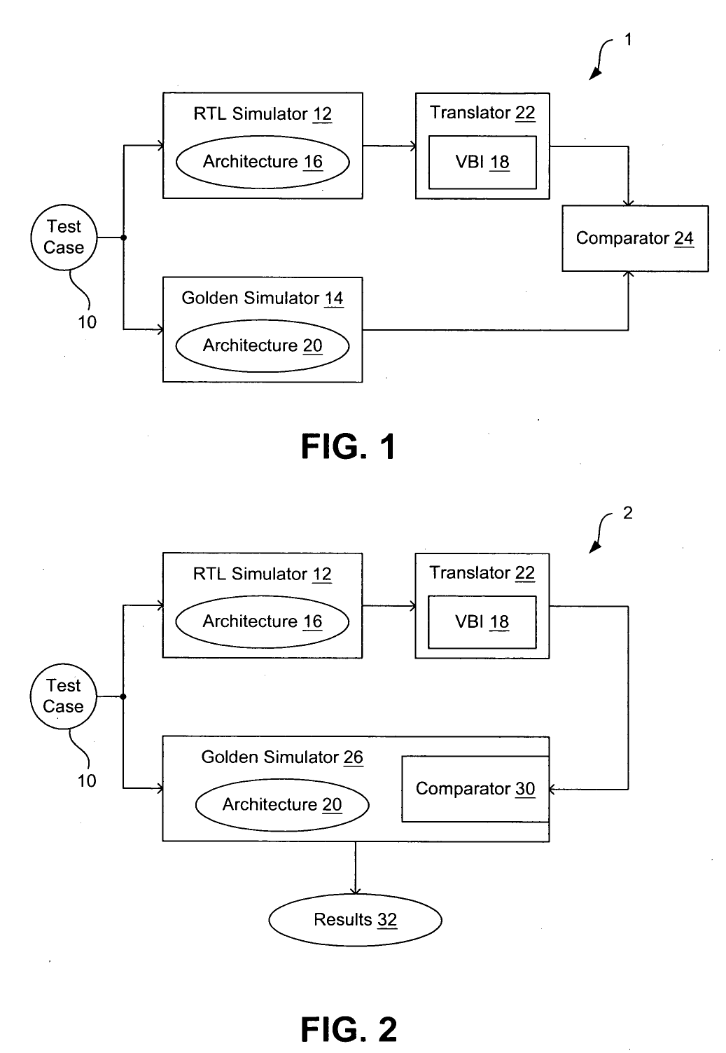

Disclosed are systems and methods for identifying unending transactions of a simulated processor architecture. Referring to FIG. 1, a processor architecture verification system 1 is illustrated that verifies processor architecture by executing at least one test case 10 on both a register transfer language (RTL) simulator 12 that comprises a compiled version of the RTL specification, and a golden simulator 14 that comprises a relatively high-level program that emulates operation of the processor. The RTL simulator 12 and the golden simulator 14 both simulate the desired architecture 16 and 20, respectively, of the processor. However, because the output of the RTL simulator 12 and the golden simulator 14 are in different formats, as will be discussed below, a translator 22 translates the output of the RTL simulator to match the format of the golden simulator. Notably, the output of the golden simulator 14 may instead be translated to match the format of the RTL simulator 12.

The translated output of the RTL simulator 12 (translated by the translator 22) is compared with the output of the golden simulator 14 in a comparator 24. If any differences in the outputs are detected by the comparator 24, the processor designer is alerted to the fact that an error may exist in the RTL simulator 12 or the golden simulator 14 or both. This enables test cases to be applied to the processor architecture quickly while minimizing required designer attention.

In the exemplary embodiment described herein, the golden simulator 14 is designed with a front side bus (FSB) output interface, while the RTL simulator 12 is designed with a point-to-point (P2P) link network output interface, as will be described in more detail below. The translator 22 comprises a virtual bus interface (VBI 18) that translates transactions from the RTL simulator 12 from P2P link network format to FSB format for comparison with the FSB format output of the golden simulator 14.

In some cases, the same golden simulator 14 may be used in the design of more than one processor, such as a family of processors all sharing the same underlying architecture. For instance, if the golden simulator 14 is designed with a given output interface in mind and a new processor is designed with a different output interface, the translator 22 enables the same golden simulator 14 to be used with the RTL simulator 12 for the new processor.

In some embodiments, the translator 22 de-pipelines the output of the RTL simulator 12 for comparison with the output of the golden simulator 14. In such an embodiment, the translator 22 may be referred to as a “depiper” for de-pipelining the output of the RTL simulator 12. The output of the RTL simulator 12 is de-pipelined in such an embodiment because the golden simulator 14 is more abstract than the RTL simulator 12. In particular, the golden simulator 14 does not include the same level of detail about the processor architecture being verified as does the RTL simulator 12. For example, the architecture, as simulated by the RTL simulator 12, may be superscalar and highly pipelined, while the golden simulator 14 simulates the architecture without this level of detail. The result is that many, e.g., 20 or 30, instructions may be acting on the RTL simulator 12 simultaneously such that the output of the RTL simulator does not match the output of the golden simulator 14 directly, even though the underlying architecture is the same and the test case is identical.

The RTL simulator 12 and the golden simulator 14 are operated relative to information specified by the test case 10. In one exemplary embodiment, the test case 10 comprises a program to be executed on the processor architecture 16 and 20 in the RTL simulator 12 and golden simulator 14. The test case program is a memory image of one or more computer executable instructions, along with an indication of the starting point, and may comprise other state specifiers such as initial register contents, external interrupt state, etc. Accordingly, the test case 10 defines an initial state for the processor that is being simulated and the environment in which it operates. The test case 10 may be provided for execution on the RTL simulator 12 and golden simulator 14 in any suitable manner, such as an input stream or an input file specified on a command line.

The RTL specification used to generate the RTL simulator 12 is, for example, implemented using the iHDL hardware description language, from the Intel Corporation of Santa Clara, Calif. Alternatively, the RTL specification may be implemented using any suitable tool for modeling the processor architecture 16, such as any register transfer language description of the architecture, which may be interpreted or compiled to act as a simulation of the processor. The RTL simulator 12 of an exemplary embodiment contains an application program interface (API) that enables external programs, including the translator 22, to access the state of various signals in the simulated processor such as register contents, input/outputs (I/Os), etc. Thus, the output of the RTL simulator 12 may be produced in any of a number of ways, such as an output stream, an output file, or as states that are probed by an external program through the API. The RTL simulator 12 may simulate any desired level of 20 architectural detail, such as a processor core, or a processor core and one or more output interfaces.

As noted above, the golden simulator 14 of the exemplary embodiment is a relatively abstract, higher-level simulation of the processor architecture 20, and therefore may be less likely to include faults or errors than the RTL simulator 12. The golden simulator 14 is written using a high level programming language such as C or C++. Alternatively, the golden simulator 14 may be written using any other suitable programming language, whether compiled, interpreted, or otherwise executed. Whereas the RTL simulator 12 actually matches the details and reality of the processor being simulated to a great degree, the golden simulator 14 is a conceptual model without concern for timing considerations arising from physical constraints.

The tasks to be performed in the architecture verification system may be divided as desired. For example, in an alternative embodiment illustrated in FIG. 2, a processor architecture verification system 2 includes a golden simulator 26 that contains a comparator 30. In the embodiment of FIG. 2, the test case 10 is executed by the RTL simulator 12 and the golden simulator 26. The results of the RTL simulator 12 are translated by the translator 22, and are fed into the golden simulator 26. The comparator 30 in the golden simulator 26 then compares the results of the golden simulation and the translated results from the RTL simulator 12, and the results 32 are made available by the golden simulator.

The translator design depends on the output formats of the RTL simulator 12 and golden simulator 14 or 26. In one exemplary embodiment, the output of the RTL simulator 12 and golden simulator 14, 26 differs due to pipeline differences in the models as well as due to different output interfaces. The RTL simulator 12 includes architectural details such as the highly-pipelined, superscalar nature of the processor. Thus, a large number of instructions may be acting on the processor at one time. In contrast, the golden simulator 14, 26, although based on the same architecture being verified, is modeled without pipelines as a simple in order machine that processes a single instruction at a time. As described above, the translator 22, in some embodiments, includes a depiper that de-pipelines the data and events in the RTL simulator 12. The output of the RTL simulator 12 is thus simplified to appear as if it were generated by a simple in-order machine, thereby enabling the comparator (e.g., 24 or 30) to compare the translated results of the RTL simulator with the results of the golden simulator 14, 26. An exemplary depiper is described in U.S. Pat. No. 5,404,496, which is incorporated by reference herein for all that it discloses.

When provided, the depiper tracks instructions as they flow through the RTL simulator 12 and notes their effects on the simulated processor. The depiper may generate a retire record for each instruction that indicates when the instruction started executing and when it completed or retired, along with the states that changed during execution. In some cases, if state changes cannot be tracked to a single instruction, the depiper may generate a generic report identifying an altered state and the instructions that may have caused the change. Thus, the output of the RTL simulator 12 is simplified for comparison with the golden simulator 14, 26.

In embodiments in which the translator 22 includes a depiper, the VBI 18 works in parallel with the depiper in the translator, with the depiper producing state change records such as depiper retire records, and the VBI producing state change records in the form of synthesized FSB transactions. Although the VBI 18 may read the P2P packets directly from the P2P interface on the RTL simulator 12 and may access information about the RTL simulated processor via the API, the VBI may also access information about the RTL simulated processor that is stored in the depiper. In some embodiments, the depiper contains structures that monitor the simulated processor core's states. In such cases, it may be convenient for the VBI 18 to access some information from the depiper for use in reporting or synthesizing fields used in the FSB phases.

In other embodiments in which the translator 22 includes a depiper, the depiper first reads the P2P output of the RTL simulator 12 and de-pipelines the P2P transactions, generating a de-pipelined version of the P2P transactions. The VBI 18 then reads the depipelined version of the P2P transactions from the depiper and generates corresponding FSB transactions for the comparator 24 or 30. The de-pipelined P2P transactions may be transferred from the depiper to the VBI 18 in any suitable manner, such as across a virtual P2P link or in a file containing depiper retire records.

The VBI 18 is not limited to use with verification systems including a depiper. Verification systems having the same level of pipelining detail in both the RTL simulator 12 and the golden simulator 14, 26 may not need a depiper, but a VBI 18 still enables processor simulators with different output interfaces to be used together. If the translator 22 includes a depiper, the VBI 18 may access information stored in the depiper as described above, or may be implemented as a module in the depiper for convenience. In embodiments in which the translator 22 does not include a depiper, the VBI 18 in the translator 22 still directly connects to the P2P output of the RTL simulator 12, but obtains other information about the state of the simulated processor from the RTL simulator via the API. The VBI 18 uses the resulting P2P packets and other information to produce translated FSB transactions in whatever manner required by the comparator 24, 30, such as generating a virtual FSB connection to the comparator, or generating output reports containing records of FSB format transactions that may be read by the comparator.

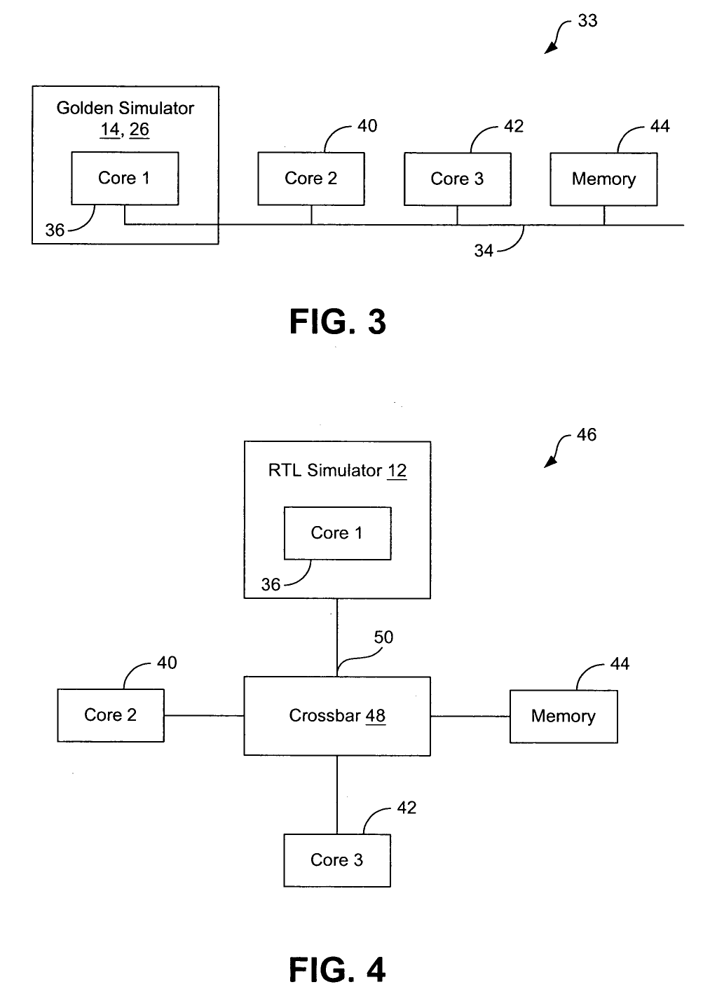

Exemplary output interfaces of the RTL simulator 12 and the golden simulator 14, 26 will now be described in more detail, as will the VBI 18 in the translator 22. FIG. 3 illustrates an example output interface 33 for the golden simulator 14, 26. As shown in that figure, the golden simulator 14, 26 uses a front side bus 34 (FSB) In the embodiment of FIG. 3, a simulated processor core 36, Core 1, based on the desired architecture 20 and simulated in the golden simulator 14, 26, is connected to the FSB 34 and therefore to external components such as other simulated processor Cores 2 and 3 (40 and 42), a memory 44, etc. Those external components 40, 42, and 44 may comprise actual physical devices. For example, the memory 44 may be a portion of the memory of the computer executing the golden simulator 14, 26. Alternatively, one or more of the external components 40, 42, and 44 may be simulated components that are either simulated by the golden simulator 14, 26 or by an external simulator. Alternatively, one or more of the external components 40, 42, and 44 may be virtual components represented by pre-programmed responses in the test case 10 that are issued by the golden simulator 14, 26 in response to transactions from the simulated Core 1 (36).

The FSB 34 is a broadcast bus in which bus traffic is visible to each component connected to the FSB and each component monitors the traffic to determine whether the traffic is addressed to them. An exemplary operation or “transaction” performed by Core 1 (36), such as a memory read operation, may comprise multiple phases. For example, consider an exemplary read operation performed by the Core 1 (36) using the FSB 34 to read data from the memory 44. The exemplary transaction comprises an arbitration phase, a request A, a request B, a snoop phase, and a data phase. Each of these five phases is performed by transmitting or receiving a block of information over the FSB 34. The comparator 24 or 30 expects to see a report for each of the five phases that acts as a state input to be compared against inputs generated by the golden simulator 14, 26. The different phases are defined in the FSB output format and place the system into various states. For example, during the snoop phase, the transaction becomes globally visible so that the transaction is visible to each core 36, 40, and 42, thereby facilitating a shared memory architecture (SMA).

In contrast, the RTL simulator 12 of the exemplary embodiments uses one or more ports into a point-to-point (P2P) link network 46 shown in FIG. 4. With reference to FIG. 4, the P2P link network 46 is a switch-based network with one or more crossbars 48 acting as switches between components such as processor cores 36, 40, and 42, memory 44, or other devices. Transactions are directed to specific components and are appropriately routed in the P2P link network 46 by the crossbar 48. This operation of the crossbar 48 reduces the load on the system components because they do not need to examine each broadcast block of information as with the FSB 34. Instead, each component ideally receives only data meant for that component. Use of the crossbar 48 also avoids bus loading issues that can plague FSB systems. Therefore the P2P link network 46 facilitates better scalability. Transactions on the P2P link network 46 are packet-based, with each packet containing a header with routing and other information. Packets containing requests, responses, and data are multiplexed so that portions of various transactions may be executed with many others at the same time. Transmissions are length limited, with each length-limited block of data called a “flit.” Thus, a long packet will be broken into several flits, and transactions will typically require multiple packets. Therefore, the P2P link network 46 is monitored over time to collect the appropriate P2P packets until enough information exists for a corresponding FSB phase to be generated by the translator 22.

The translator VBI 18 translates entire transactions by reading the P2P packets and generating corresponding FSB phases for the transaction so that the transactions can be compared by the comparator 24, 30 with transactions from the golden simulator 14, 26. The translator 22 may be designed to only monitor packets passing in and out of the simulated Core 1 (36), and/or may monitor other packets in the P2P link network 46 if desired. In the exemplary embodiment illustrated in FIG. 4, the translator 22 monitors the port 50 on the crossbar 48 that is connected to the simulated Core 1 (36) in the RTL simulator 12.

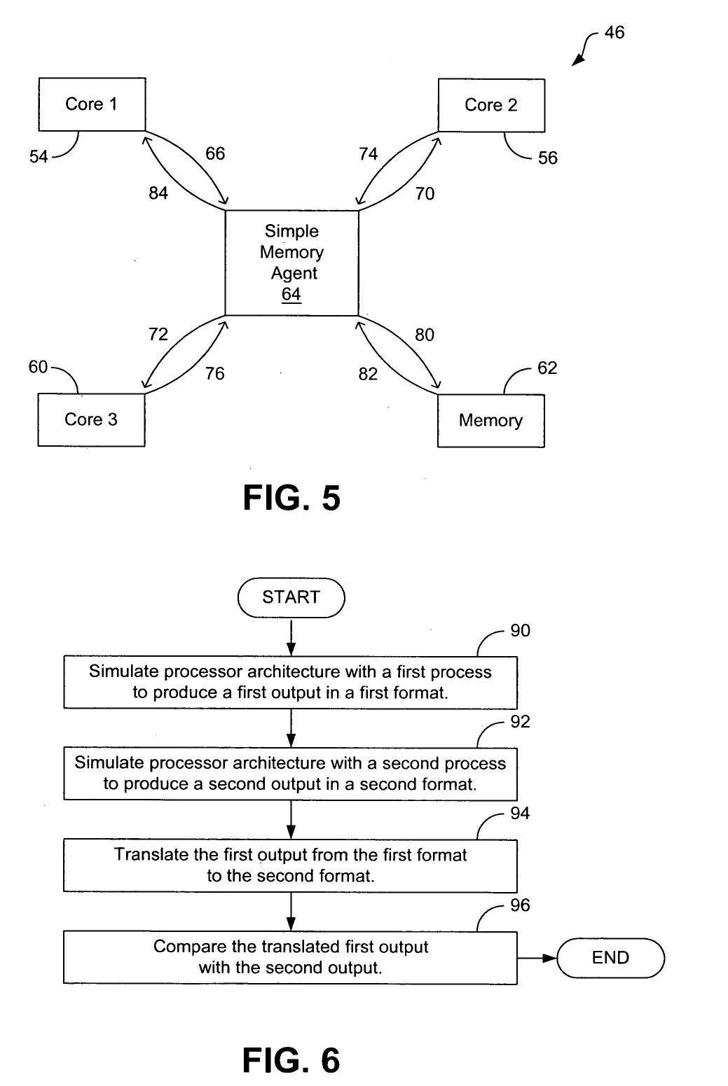

An exemplary read operation in a P2P link network is illustrated in FIG. 5. The P2P link network 52 in this example comprises three simulated processor cores 54, 56, and 60 (i.e. Cores 1, 2, and 3), a memory 62, and a simple memory agent 64. (Note that the diagram of FIG. 5 illustrates logical data flow, not physical connections, and that a crossbar through which all packets flow is not shown.) The first core 54 (Core 1) is simulated in an RTL simulator, although the other components 56, 60, 62, and 64 may also be simulated as discussed above. The term “data line” refers to a line of data, such as a computer-executable instruction line, which is stored in the memory 62 and copies of which may also be temporarily stored in caches in one or more of the cores 54, 56, and 60. The term “simple” with respect to the simple memory agent 56 indicates that no directory of data line locations exists, such that the simple memory agent 56 is unaware of which component in the system is holding the controlling version of any given data line.

During the read operation, Core 1 (54) sends a packet 66 to the simple memory agent 64 requesting a line of data. Because the system does not include a directory, the simple memory agent 64 does not know where the controlling version of the line being read is located. Therefore, the simple memory agent 64 sends packets 74 and 72 to each of the other cores 56 and 60 (i.e. Cores 2 and 3), respectively, inquiring as to whether those cores contain a controlling copy of the line. Assuming in this example that they do not, each core 56, 60 responds with a packet 70 and 76, respectively, indicating that they do not have a copy of the line. The simple memory agent 64 then sends a packet 80 to the memory 62, which responds with a packet 82 containing the line to the simple memory agent 64. The simple memory agent 64 then sends a packet 84 containing the line to the requesting core 54.

Each of the packets described in the above example may be divided into multiple flits. Furthermore, depending on the particular protocol of the P2P link network, additional packets may be transmitted over the P2P link network 52 during the transaction, for example to indicate that the transaction is complete. Thus, packets in the P2P link network format are formatted and divided much differently than corresponding FSB phases of a transaction, and each may include information not provided in the other format.

An example of the operation of the translator 22 will now be described. It is noted that multiple P2P packets and FSB phases may be involved in a single transaction such as a read or write operation. Furthermore, a transaction may be divided differently in the P2P and .FSB formats. Therefore, the translator 22 translates by transaction rather than by P2P packet in the following exemplary operation. However, not all P2P packets for a given transaction need be received before beginning to generate corresponding FSB phases for the transaction. For example, after receiving the second P2P packet in a five-packet transaction, it may be possible to generate the second corresponding FSB phase if sufficient information has been received.

The translator 22 monitors each virtual channel, both incoming and outgoing, on each selected P2P port. For example, the translator 22 may be configured to monitor all input and output ports on the simulated processor core. The translator 22 tracks the ports clock tick by clock tick. The clock may be a source clock in the P2P output interface of the simulated core, a clock signal in the virtual P2P link network wires, etc. The translator 22 first assembles transmissions into packets, which may comprise receiving multiple flits to form a packet, as described above.

When a packet has been received, its header is examined to see if the packet type is one that indicates that the packet should be translated or discarded. Only P2P packets corresponding to an FSB phase in a transaction are translated. For example, flow control packets or bus status packets relating to the P2P link network 46 that have no analogue in the FSB protocol are not translated. When the first packet of a transaction has been received, a packet list for that transaction is created to contain or identify all received packets for that transaction. When additional packets for that transaction are received, they are added to the appropriate packet list. The transactions being translated are managed and accessed by an associative array containing pointers to the packet lists for each transaction. Each transaction is assigned a transaction identifier or ID, “txnid,” which is used as an index into the associative array, as follows: transactionx{txnid}. The first entry in the packet list for each transaction contains information about the transaction, such as the transaction type (e.g., read, write, interrupt) and location, whether the packet is incoming or outgoing, timing information, and the port and channel. Each transaction that has had some activity during the current clock tick is marked as active using another associative array as follows: active{txnid}=1.

Once all monitored channels have been processed as described above for the current clock tick, the list of active transactions for this clock tick is processed to determine if an FSB phase may be generated based on the information received to this point. The type of each active packet list is noted, and each active packet list is scanned to determine whether, based on the packet type, an FSB phase for the transaction can be generated. If an FSB phase is generated based on packets in the packet list, the packet list is annotated to indicate that the FSB phase has been generated, preventing later generation of a duplicate FSB phases. Lookup tables are used in the exemplary translator 22 to generate FSB phases corresponding to one or more P2P packets. Meta-informational values in the FSB phases are translated from the packet list as well, such as request step time, a unique FSB transaction number, etc. FSB fields such as transaction type, address, code, write-snoop, lock, drv_ads, length, attribute, hit, hitm, etc., may be filled in with default values, or using a lookup table to translate from values in the packet list, or synthesizing new information. This synthesizing may be performed by using the transaction/packet type in the translation function, reading signals from other parts of the simulation, or from other information. For example, the signal delay from a data bus to a control path may be added to an observability time. Packets other than those triggering a reporting event may also be examined to determine proper field contents. It is also noted that some information may not need to be included in FSB phases if the information is not needed by the comparator 24 for verifying the simulated core. In such cases, dummy values may be inserted. The translator 22, 30 may also perform any other appropriate functions such as rearranging the byte/word order in a line of data because of critical-chunk differences in the output interfaces, or changing the reported “completion time” based on the type of transaction. Once a transaction has been completely translated, it is removed from the list of transactions being processed. The active transaction list is also cleared at the end of translation processing for a clock tick to prepare for the next clock tick.

As discussed above, translation details are dependent upon the differences between the golden simulator 14, 26 and the RTL simulator 12, such as the output interfaces and the level of architectural detail included in each. It will therefore be understood that the translator 22 may be adapted by one skilled in the art based upon the differences between the golden simulator 14, 26 and the RTL simulator 12.

In summary, the architecture of a processor design may be verified by simulating the processor architecture with a first process 90 (FIG. 6) to produce a first output in a P2P link network format and with a second process 92 to produce a second output in a FSB format. For example, as described above with respect to one exemplary embodiment, the first process may comprise an RTL simulation of a highly pipelined processor with a P2P link network output, the second process may comprise a golden simulation of a simple in-order machine that processes a single instruction at a time, with an FSB output, both based on the same architecture. The first output is translated 94 from the P2P link network format to the FSB format, and the translated first output is compared 96 with the second output.

As noted above, there are several obstacles to effectively verifying a processor design, including identifying transactions that do not complete or end. Such unending transactions may not be detected in P2P interfaces, such as that used in the RTL simulator 12, due to the configuration and operation of such interfaces. For instance, assume each core of a simulated processor sends many transaction requests to the interface crossbar. If a given transaction is initiated by one of the cores and no other transaction is initiated having the same transaction ID, the failure of the transaction to complete may never be detected by the VBI 18. Unfortunately, the golden simulator 14, 26 is unlikely to identify such an unending transaction given its relatively high-level nature. Therefore, the processor designer may not be alerted to the fact that the transaction did not end and, therefore, that there may be a flaw in the processor design. If, on the other hand, another transaction is initiated having the same transaction ID, the VBI 18 may become terminally confused and the verification test may ultimately fail with ambiguity as to the cause.

Such unending transactions can be detected, however, if the VBI 18 is configured to monitor the time it takes for transactions to complete, and time out transactions that do not so complete. In such a case, the unending transactions can be flagged and later evaluated by the processor designer.

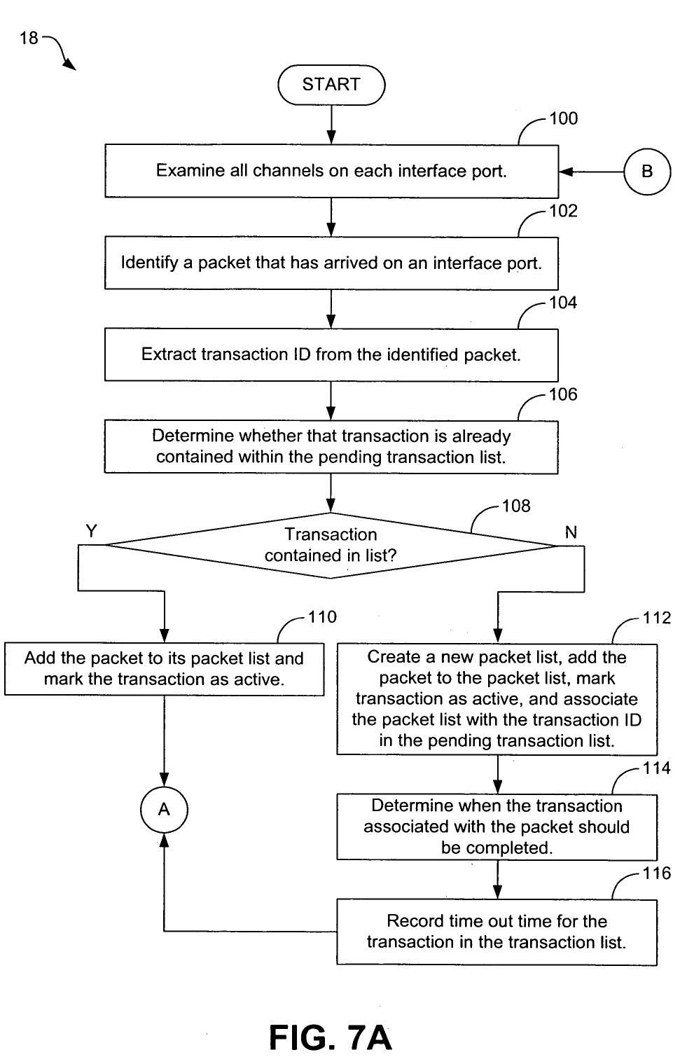

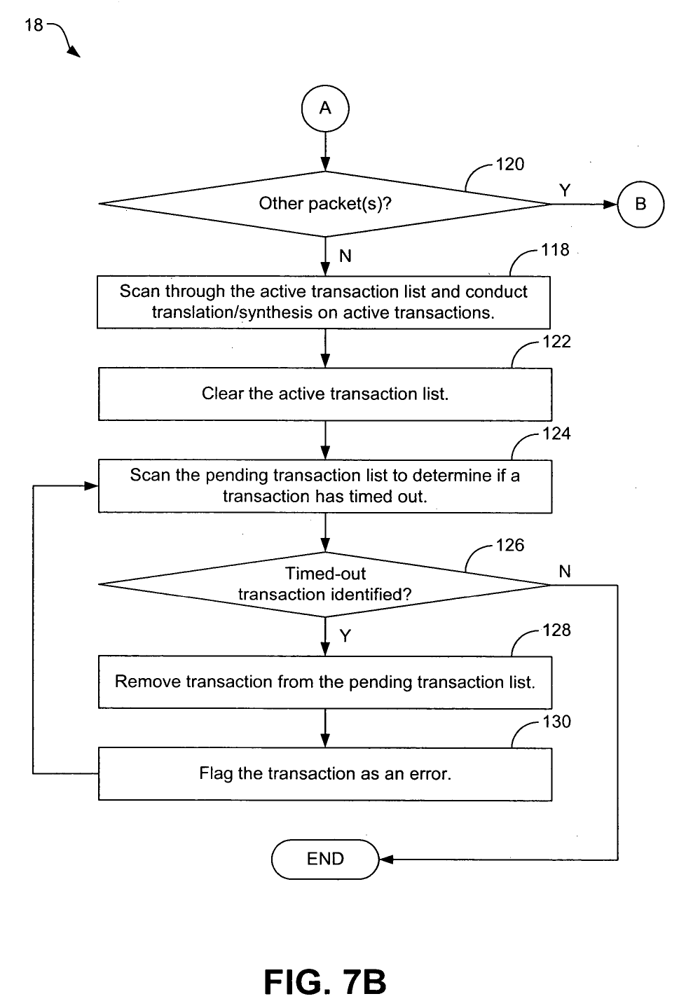

FIGS. 7A and 7B describe an example method for identifying unending transactions in a P2P interface. More particularly, FIGS. 7A and 7B describe an example of operation of the VBI 18 in monitoring transactions generated in a P2P link network of the RTL simulator 12 (e.g., network 46, FIG. 4) and flagging transactions that do not complete. By way of example, the flow described in relation to FIGS. 7A and 7B occurs each clock tick.

Beginning with block 100 of FIG. 7A, the VBI 18 monitors the P2P interface (link network) to examine all channels on each interface port so as to identify packets that are issued by any P2P component (e.g., core). Such examination is possible in that, because the VBI 18 monitors each channel of the P2P interface, the VBI can therefore “see” all traffic that is transmitted over the interface. Through the examination, the VBI 18 can identify a packet that has arrived on an interface port, as indicated in block 102. Once having identified such a packet, the VBI 18 extracts a transaction ID from the packet, as indicated in block 104. As described above in relation to FIG. 5, the transaction ID is contained in the packet header and is assigned by the agent that initiated the transaction. The transaction ID identifies the packet as pertaining to a given transaction and all packets that so pertain to that transaction will comprise the same transaction ID.

Referring next to block 106, the VBI 18 determines whether the transaction identified by the transaction ID is contained within the pending transaction list. That determination may comprise, for example, performing a lookup operation within the transaction list using the transaction ID as a key. With reference next to decision block 108, if the transaction is contained in the transaction list, a packet associated with that transaction has previously been identified and, therefore, a time out time has already been determined for that transaction. In such a case, the VBI 18 adds the packet to its packet list and marks the transaction as active in the active transaction list. Flow from this point continues to block 118 of FIG. 7B described below.

With reference back to decision block 108, if the packet does not identify a transaction that is already contained in the pending transaction list, the packet is the first packet of a new transaction. In that case, flow continues to block 112 at which the VBI 18 creates a new packet list to which the packet is added, marks the associated transaction as active in the active transaction list, and the associates the new packet list with the transaction ID in the pending transaction list. Through such operation, the packet list can be accessed from the pending transaction list using the transaction ID as a key.

At this point, the VBI 18 establishes rules for deciding whether a given transaction is improperly not completing or ending. In particular, the VBI 18 first determines when the transaction should be completed, as indicated in block 114. That determination may comprise, for example, noting the arrival time of the packet on the P2P interface and the transaction type (e.g., read, write, interrupt, etc.), and using that information as inputs into a time-out function that calculates an estimated time that the transaction should take to complete. Such a time-out function may comprise part of the VBI 18, or may comprise a separate function that is accessible to the VBI. Regardless, the function may take system parameters, such as a particular attribute of the simulated processor, into account in calculating the estimated time. The estimated time is measured in terms of interface or core clock ticks, depending upon the implementation. Although use of such a function has been described, an appropriate lookup table could alternatively be used to provide the same functionality, i.e. to provide an estimated completion time in relation to particular inputs.

Once the completion time has been determined, the VBI 18 next records a time out time in the pending transaction list for that transaction, as indicated in block 116, to generate a reference against which to check when pending transactions are reviewed to determine whether they have timed out (see, e.g., block 124 of FIG. 7B).

Referring next to decision block 120 of FIG. 7B, flow then depends upon whether there are one or more other packets to process. If so, flow returns to block 100 of FIG. 7A and the various interface channels are again examined to identify the packet(s). If there are no other packets to process, however, the initial packet processing for the present clock tick has been completed and flow continues to block 118 at which the VBI 18 scans through the active transaction list and conducts the translation and/or synthesis on the active transactions as described in detail in relation to FIG. 5. Such translation and/or synthesis is only performed on those transactions that considered significant to the verification testing, i.e. those for which there is an analogue in the FSB protocol. Notably, the other transactions may be disregarded by the VBI 18 early in the described process (e.g., before the transaction ID is extracted in block 104 of FIG. 7A).

After the translation/synthesis has been performed, the VBI 18 clears the active transaction list, as indicated in block 122, and then scans the pending transaction list to determine if a transaction has timed out, as indicated in block 124. The time out determination can be made with reference to finish criteria defined for the particular transaction by the P2P interface. By way of example, the finish criteria for a given transaction may comprise arrival of a certain packet, receipt of a certain number of responses from other cores of the interface, etc. With reference to decision block 126, the VBI 18 then determines whether the transaction at issue has already timed out. In other words, the VBI 18 determines whether the time out time determined in block 114 and recorded in block 116 has been exceeded by referring to the present clock tick. If no transaction has timed out, no unending transactions have been detected and flow for the present clock tick is terminated. If, on the other hand, a transaction has timed out, it is presumed that the transaction has failed to complete, potentially due to a flaw in the processor design. In such a case, flow continues to block 128 of FIG. 7B at which the VBI 18 removes the transaction from the pending transaction list. At this point, the VBI 18 flags the transaction as an error, as indicated in block 130. Such flagging may comprise, for example, failing the case so as to place the transaction in a category of cases that the processor designer must debug. In addition, such flagging may comprise generating debug information that provides details of the unending transaction including, for instance, the identity of the particular transaction, the time the failure to complete was determined, the action that was missing for the transaction to complete, etc. Furthermore, flagging may comprise presenting (e.g., printing) all of the relevant information contained in the packet header including, for example, the identity of the agent that initiated the transaction, the transaction type, the packet address, the packet destination, etc.

After the unending transaction has been flagged, flow returns to block 124 at which the VBI 18 again scans the pending transaction list to see if there are one or more other transactions to check. If so, flow continues in the same manner as described above in relation to blocks 126-130 and all unending transactions are flagged.

The operation described above alerts the processor designer to the failure to complete and, therefore, to a potential flaw in the processor design. In addition, removal of the unending transaction from the pending transaction list enables the VBI 18 to continue processing transactions that occur beyond the point at which the transaction timed out, in particular those with the same transaction ID.

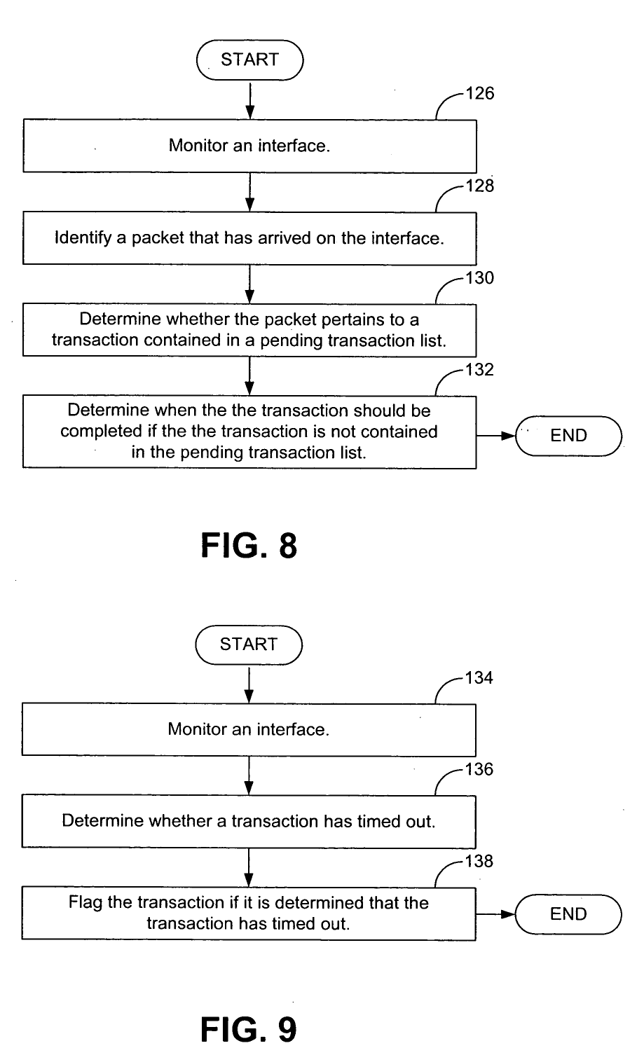

In view of the above, a method for identifying unending transactions can be summarized as indicated in FIG. 8. Such a method comprises monitoring an interface (block 126), identifying a packet that has arrived on the interface (block 128), determining whether the identified packet pertains to a transaction contained in a pending transaction list (block 130), and determining when the transaction should be completed if the transaction is not contained in the pending transaction list (block 132).

A method for identifying unending transactions can also be summarized as indicated in FIG. 9. Such a method comprises monitoring an interface (block 134), determining whether a transaction has timed out (block 136), and flagging the transaction if it is determined that the transaction has timed out (block 138).

Various computer-readable or executable code or electronically-executable instructions have been described herein. Such code or instructions may be implemented in any suitable manner, such as software, firmware, hard-wired electronic circuits, as the programming in a gate array, etc. Software may be programmed in any programming language, such as machine language, assembly language, or high-level languages such as C or C++. The computer programs may be interpreted or compiled.

Computer-readable code, executable code, or electronically-executable instructions may be tangibly embodied on any computer-readable storage medium or in any electronic circuitry for use by or in connection with any instruction-executing device, such as a general purpose processor, software emulator, application specific circuit, a circuit made of logic gates, etc. that can access or embody, and execute, the code or instructions.

Methods described and claimed herein may be performed by the execution of computer readable or executable code or electronically executable instructions, tangibly embodied on any computer-readable storage medium or in any electronic circuitry as described above.

A storage medium for tangibly-embodying computer readable code, executable code, or electronically-executable instructions includes any means that can store, transmit, communicate, or in any way propagate the code or instructions for use by or in connection with the instruction-executing device. For example, the storage medium may include (but is not limited to) any electronic, magnetic, optical, or other storage device, or any transmission medium such as an electrical conductor, an electromagnetic, optical, infrared transmission, etc. The storage medium may alternatively comprise an electronic circuit, with the code or instructions represented by the design of the electronic circuit. Specific examples include magnetic or optical disks, both fixed and removable, semiconductor memory devices such as memory cards and read-only memories (ROMs), including programmable and erasable ROMs, non-volatile memories (NVMs), optical fibers, etc. Storage media for tangibly-embodying code or instructions also include printed media such as computer printouts on paper which may be optically scanned to retrieve the code or instructions, which may in turn be parsed, compiled, assembled, stored and executed by an instruction-executing device. The code or instructions may also be tangibly embodied as an electrical signal in a transmission medium such as the Internet or other types of networks, both wired and wireless.

1. A method for identifying unending transactions, the method comprising:
monitoring an interface;
determining whether a transaction has timed out; and
flagging the transaction if it is determined that the transaction has timed out.

2. The method of claim 1, wherein monitoring an interface comprises monitoring a point-to-point (P2P) link network.

3. The method of claim 1, wherein monitoring an interface comprises monitoring a point-to-point (P2P) link network of a register transfer language (RTL) simulator.

4. The method of claim 1, wherein determining whether a transaction has timed out comprises consulting a pending transaction list.

5. The method of claim 4, wherein determining whether a transaction that has timed out further comprises identifying a recorded time out time and determining if that time has been exceeded.

6. The method of claim 1, wherein flagging the transaction comprises failing a case so as to place the transaction in a category of cases that are to be debugged.

7. The method of claim 1, wherein flagging the transaction comprises generating debug information that provides details of the transaction including at least one of an identity of the transaction, a time failure to complete was determined, and an action that was missing for the transaction to complete.

8. The method of claim 1, wherein flagging the transaction comprises presenting information contained in a header of a received packet to a user.

9. The method of claim 1, further comprising removing the transaction from a pending transaction list.

10. A method for identifying unending transactions, the method comprising:
monitoring an interface;
identifying a packet that arrives on the interface;
determining whether the packet pertains to a transaction contained in a pending transaction list; and
determining when the transaction should be completed if the transaction is not contained in the pending transaction list.

11. The method of claim 10, wherein monitoring an interface comprises monitoring a point-to-point (P2P) link network.

12. The method of claim 10, wherein monitoring an interface comprises monitoring a point-to-point (P2P) link network of a register transfer language (RTL) simulator.

13. The method of claim 10, wherein determining whether the packet pertains to a transaction contained in a pending transaction list comprises extracting a transaction identifier (ID) from the packet and determining whether the transaction ID is contained in the pending transaction list.

14. The method of claim 10, wherein determining when the transaction should be completed comprises inputting a packet arrival time and a transaction type into a time-out function.

15. The method of claim 10, wherein determining when the transaction should be completed comprises using a packet arrival time and a transaction type to look up a time out time in a table.

16. The method of claim 10, further comprising recording a time out time in the pending transaction list for the transaction to which the packet pertains.

17. A system for identifying unending transactions, the system comprising:
means for monitoring an interface;
means for identifying packets that arrive on the interface;
means for determining when a transaction should be completed; and
means for determining when a transaction has timed out.

18. The system of claim 17, wherein the means for monitoring an interface comprise means for monitoring a point-to-point (P2P) link network.

19. The system of claim 17, wherein the means for determining when a transaction should be completed comprise a time-out function.

20. The system of claim 17, wherein the means for determining when a transaction should be completed comprise a look up table.

21. The system of claim 17, wherein the means for determining when a transaction has timed out comprise means for determining a time out time from a pending transaction list using a transaction identifier (ID).

22. The system of claim 21, wherein the means for determining a time out time comprise means for identifying a recorded time out time stored in the transaction list and means for determining if that time has been exceeded.

23. The system of claim 17, further comprising means for flagging unending transactions.

24. A virtual bus interface (VBI) stored on a computer-readable medium, the virtual bus VBI comprising:
logic configured to monitor a point-to-point (P2P) interface;
logic configured to identify packets that arrive on the P2P interface;
logic configured to determine a time out time for a transaction to which a packet pertains; and
logic configured to determine when a transaction has timed out.

25. The VBI of claim 24, wherein the logic configured to determine a time out time comprises a time-out function.

26. The VBI of claim 24, wherein the logic configured to determine a time out time comprises logic configured to look up times contained in a table.

27. The VBI of claim 24, wherein the logic configured to determine when a transaction has timed out comprises logic configured to determine a time out time from a pending transaction list using a transaction identifier (ID).

28. The VBI of claim 27, wherein the logic configured to determine a time out time comprises logic configured to identify a recorded time out time stored in the transaction list and logic configured to determine if that time has been exceeded.

29. The VBI of claim 24, further comprising logic configured to flag unending transactions.

30. A processor architecture verification system, comprising:
a register transfer language (RTL) simulator that simulates operation of a processor and generates a first output in a first format, the RTL simulator including an interface;
a golden simulator that simulates operation of the processor and generates a second output in a second format;
a translator that translates at least one of the outputs for comparison with the other output, the translator including a virtual bus interface (VBI) that comprises logic configured to monitor a the RTL simulator interface, logic configured to determine a time out time for a transaction to which a packet on the RTL simulator interface pertains, and logic configured to determine when a transaction has timed out; and
a comparator that compares the first and second outputs after translation of the at least one output.

31. The system of claim 30, wherein the logic configured to determine a time out time comprises a time-out function.

32. The system of claim 30, wherein the logic configured to determine a time out time comprises logic configured to look up times contained in a table.

33. The system of claim 30, wherein the logic configured to determine when a transaction has timed out comprises logic configured to determine a time out time from a pending transaction list using a transaction identifier (ID).

34. The system of claim 30, wherein the VBI further comprises logic configured to flag unending transactions of the RTL simulator.
